(19) United States
(12) Patent Application Publication
(10) Pub. No.: US 2009/0034696 A1
(43) Pub. Date: Feb. 5, 2009

(54) MECHANISM OF DISTRIBUTING VOICE CALL USING EMAIL DISTRIBUTION GROUPS

(75) Inventor: Rajesh Ramanathan, Redmond, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/832,272

(22) Filed: Aug. 1, 2007

(51) Int. Cl. H04M 1/64; H04M 7/00

(52) U.S. Cl. 379/88.17; 379/220.01

(57) ABSTRACT

The claimed subject matter provides a system and/or a method that facilitates routing an incoming data communication in connection with unified communications. A unified communications component can employ unified communications for a data communication with an email data communication mode, a voice data communication mode, an instant messaging data communication mode, and a voicemail data communication mode. A distribution component can automatically route the data communication to an entity utilizing a distribution group, the distribution group includes at least one entity with a public switched telephone network (PSTN) number and a session initiation protocol (SIP) uniform resource identifier (URI).

### BACKGROUND

Technological advances in computer hardware, software and networking have lead to increased demand for electronic information exchange rather than through conventional techniques such as paper correspondence, for example. Such electronic communication can provide split-second, reliable data transfer between essentially any two locations throughout the world. Many industries and consumers are leveraging such technology to improve efficiency and decrease cost through web-based (e.g., on-line) services. For example, consumers can purchase goods, review bank statements, research products and companies, obtain real-time stock quotes, download brochures, etc. with the click of a mouse and at the convenience of home.

In light of such technological advances, people in general tend to be more and more concerned about being connected and/or available for various communications such as cell phone calls, text messages, emails, instant messages, land line phone calls, voice mails, etc. In addition, the non-stop, fast-paced mentality of today's society demands responsiveness and if not provided, impatience and dissatisfaction sets in. Such responsiveness can be crucial to businesses, companies, enterprises, etc. in order to provide superior customer satisfaction since customer satisfaction plays a significant role in a fruitful business venture. For example, a company who handles incoming customer communications in an efficient and prompt manner will have an excellent reputation which yields high customer return, customer recommendations, and overall pleasing ratings from customers. For companies who do not strive to satisfy customers, such characteristic can be detrimental to business and success. Thus, providing customer care in prompt and efficient manner can be a very good barometer in determining the potential success or failure of a company, business, enterprise, etc. In addition, handling incoming data communications in an effective and/or organized manner can prove to be prosperous for any individual, company, home, office, etc.

In general, call distribution and hunt groups related to a private exchange branch (PBX) can assist in managing and/or directing incoming data communications. Hunt groups can be used to distribute calls to a set of users and/or machines whenever a particular number is dialed and/or activated. On the other hand, a call distribution feature in the private exchange branch (PBX) allows a call and/or data communication to be routed to a particular user and/or machine (e.g., a most idle user/machine first, a set of machines/users simultaneously, etc.). Although sufficient in the past, call distribution and hunt groups related to PBX are inefficient, costly, rigid, and/or technologically behind based upon administrative burdens (e.g., setup, management, configuration, re-configuration upon change, etc.) and with the advent of unified communications.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methods that facilitate utilizing a distribution group to route data communications within unified communications. A distribution component can automatically route voice data communications within unified communications utilizing a distribution group. The distribution group can be linked and/or associated with a PSTN number and a SIP URI in order to allow a VoIP network to initiate data communications therewith. In addition, the distribution component can leverage an email application and/or an email component that includes an email distribution group, wherein the distribution component can create a distribution group from the email distribution group to automatically route voice communications. Thus, an email distribution group and respective membership can be mapped by the distribution group to enable voice communication routing and/or directing.

In another aspect in accordance with the subject innovation, a persistent chat component can implement a persistent chat room associated with a distribution group and respective members with the use of the SIP URI. The persistent chat room can correlate to the distribution group in which data communications can be initiated by utilizing the distribution group. Furthermore, a status and/or presence indicator can be provided for at least one of the distribution group and/or a portion of members within the distribution group. The status and/or presence indicator can provide insight on whether a member and/or a portion of members are available for data communications (e.g., voice, audio, instant messaging, video, email, etc.). In other aspects of the claimed subject matter, methods are provided that facilitate extending an email distribution group to disparate data communications within a unified communication network to enable enhanced communication capabilities.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates utilizing a distribution group to route data communications within unified communications.

FIG. 2 illustrates a block diagram of an exemplary system that facilitates integrating an email distribution group to data communications within unified communications.

FIG. 3 illustrates a block diagram of an exemplary system that facilitates managing a distribution group across a plurality of data communication modes within unified communications.

FIG. 4 illustrates a block diagram of an exemplary system that facilitates extending an email distribution group to disparate data communications within a unified communication network to enable enhanced communication capabilities.

FIG. 5 illustrates a block diagram of exemplary system that facilitates directing an incoming data communication utilizing a distribution group in connection with unified communications.

FIG. 6 illustrates a block diagram of an exemplary system that facilitates extending an email distribution group to disparate data communications within a unified communication network to enable enhanced communication capabilities.

FIG. 7 illustrates an exemplary methodology for utilizing a distribution group to route data communications within unified communications.

FIG. 8 illustrates an exemplary methodology that facilitates integrating an email distribution group to data communications within unified communications.

FIG. 9 illustrates an exemplary networking environment, wherein the novel aspects of the claimed subject matter can be employed.

FIG. 10 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “interface,” “server,” “directory,” “multipoint conferencing unit,” and the like are intended to refer to a computer-related entity, either hardware, software (e.g., in execution), and/or firmware. For example, a component can be a process running on a processor, a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

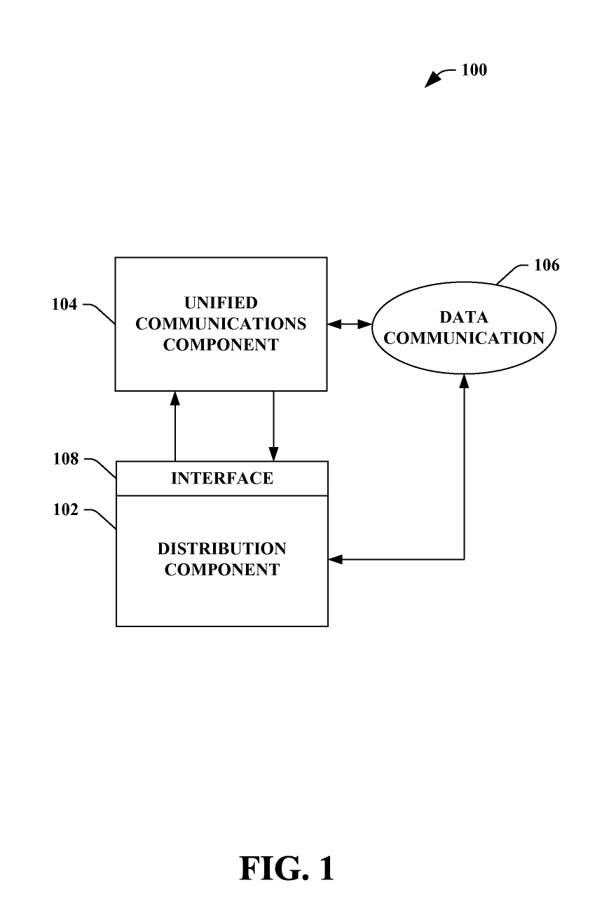

Now turning to the figures, FIG. 1 illustrates a system 100 that facilitates utilizing a distribution group to route data communications within unified communications. The system 100 can include a distribution component 102 that can automatically route and/or direct a data communication 106 utilizing a distribution group, wherein the data communication can be related to any suitable data communication mode associated with unified communications provided by a unified communications component 104. For instance, the data communication modes associated with unified communications can be, but are not limited to, an email data communication mode, a voice data communication mode, an audio data communication mode, an instant messaging data communication mode, a video data communication mode, and/or a voicemail data communication mode. Generally, the distribution component 102 can route and/or direct incoming data communications to entities/members defined by the distribution group. In particular, the distribution component 102 can utilize a distribution group to route data communications in which the distribution group can define at least one entity/member with a respective public switching telephone network (PSTN) number and a session initiation protocol (SIP) uniform resource identifier (URI). By employing the distribution group with a PSTN number and a SIP URI, the distribution component 102 can enable automatic routing of voice data communications in a cost efficient and low maintenance manner. In other words, the distribution component 102 can utilize a distribution group to transfer and/or redirect data communications, wherein the distribution group can be associated with an entity, a PSTN number, and/or a SIP URI. It is to be appreciated that the distribution group with linked PSTN number enables universal implementation across any voice data communication (e.g., cellular network, internal network, unified communication network, outside network communications, external network communications, land lines, etc.) activating the PSTN number. In other words, the distribution group can be activated and/or utilized by any suitable voice data communication that can access the PSTN number that is linked and/or correlates to the distribution group and respective members. Thus, the distribution group can include a PSTN facing phone number and a SIP URI that can be called and/or utilized by a voice over Internet protocol (VoIP) network (not shown). It is to be further appreciated that the system 100 can be utilized with a myriad of products, applications, software, and/or hardware. For example, the system 100 can be utilized in connection with an email distribution group such as a universal distribution group in a directory (e.g., a directory service associated with an operating system that is a centralized and standardized system that automates network management of user data, security, distributed resources, directory interoperation, etc.).

For example, a distribution group can be utilized to route and/or direct data communications within unified communications for various data formats, modes, types, etc. By linking a PSTN number and a SIP URI to the distribution group, incoming voice communications can be routed and/or directed seamlessly within unified communication networks and/or systems. For instance, the activation and/or initiation of a PSTN number that is linked to a distribution group can allow the members of the distribution group to receive the data communication. Generally, the distribution group can be utilized for voice communications and can appear in a directory to enable data communication (e.g., send emails, voice conversations, instant messaging, etc.).

In another example, the distribution component 102 can leverage distribution groups associated and/or utilized with various email applications/software, calendar applications/software, instant messaging applications/software, etc., wherein such leveraging enables the distribution group members/entities to be extended to voice communication routing utilizing a PSTN number and SIP URI for members/entities. Generally, any suitable distribution group can be utilized by the distribution component 102 in order to expand and/or extend into routing voice communications utilizing a PSTN number and an SIP URI. In particular, an email distribution group can be created to direct emails to certain email address(es). Such distribution group can be leveraged by the distribution component 102 in which a PSTN number and SIP URI can be associated for each existing member/entity. For each member of the distribution group, an email address, a PSTN number and SIP URI can be provided in order to allow routing of data communications. Thus, an email directed to the distribution group can be routed to the email addresses associated with the members/entities and a voice communication directed to the PSTN number linked to the distribution group can be routed to the SIP URIs associated with the members/entities. For instance, an existing email distribution group can be extended (e.g., linked to a PSTN number and SIP UIR, etc.) with the distribution component 102 by adding an additional property in the form of extensible markup language (XML) configuration that can be utilized by client side applications to apply rules when directing data communications to the distribution group and/or list.

It is to be appreciated that the unified communications component 104 can be an integrated enterprise communication client which can enable data communications (e.g., real-time, etc.) utilizing various data communication modes such as, but not limited to, email, instant messaging, voice over Internet protocol (VoIP) communication, video conferencing, audio, voice, desktop sharing, application sharing, etc. Furthermore, the unified communications component 104 can further enable integration of various computer applications and/or software within the data communication such as, but not limited to, a word processing application, a data spreadsheet application, a presentation/slide creation program, an email application (e.g., leveraging off of address books, contact information, etc.), note taking applications, information gathering applications, multi-user collaboration note taking applications, desktop sharing applications, shared workspace applications, proprietary peer-to-peer software applications, and/or enterprise portal applications. In other words, the unified communications component 104 can employ real-time communications in various data communication modes in which numerous applications and/or software can be leveraged in order to enhance the real-time communication experience.

In addition, the system 100 can include any suitable and/or necessary interface component 108 (herein referred to as “interface 108”), which provides various adapters, connectors, channels, communication paths, etc. to integrate the distribution component 102 into virtually any operating and/or database system(s) and/or with one another. In addition, the interface component 108 can provide various adapters, connectors, channels, communication paths, etc., that provide for interaction with the distribution component 102, unified communications component 104, the data communication 106, and any other device and/or component associated with the system 100.

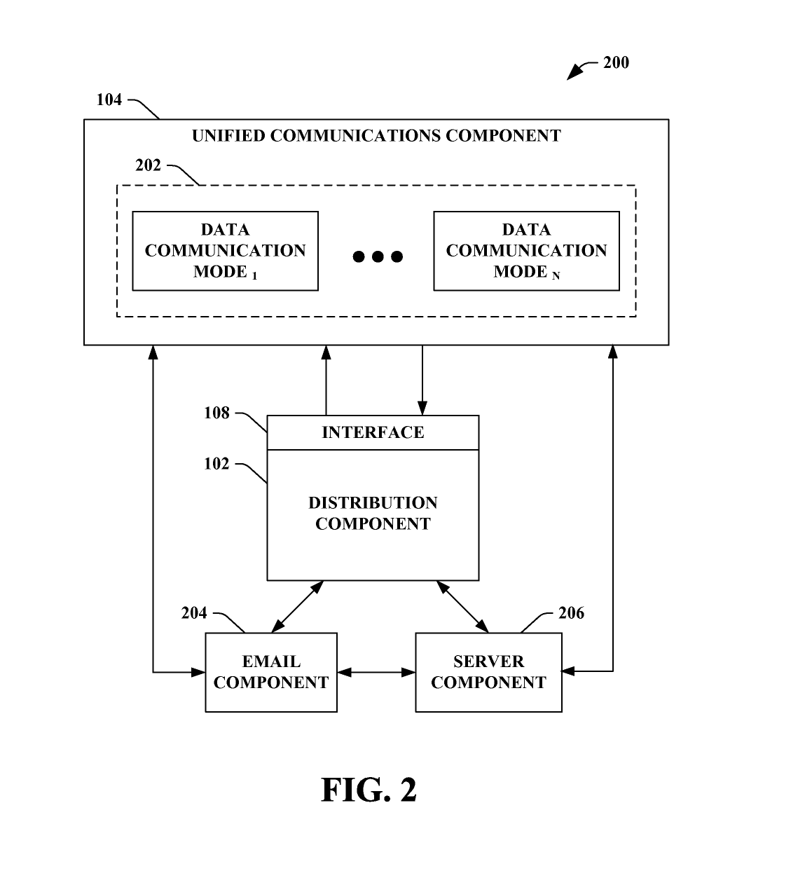

FIG. 2 illustrates a system 200 that facilitates integrating an email distribution group to data communications within unified communications. The system 200 can include the distribution component 102 that can implement a distribution group to route and/or direct data communications, wherein the distribution group can be associated with a PSTN number and a SIP URI for voice communication routing and/or directing. In other words, a distribution group utilized with data communications can be enhanced to route voice communications and/or incoming PSTN communications. The distribution component 102 can link a PSTN number to a distribution group, wherein members/entities of the distribution group can be routed utilizing SIP URIs.

It is to be appreciated that the distribution group utilized by the distribution component 102 can be applicable to any suitable data communication associated with unified communications. For instance, the unified communications component 104 can employ data communications in connection with unified communications, wherein the distribution group can redirect, forward, and/or route data communications (e.g., incoming data communications) regardless of the data communication mode 202. It is to be appreciated that there can be any suitable number of data communication modes 202 such as, but not limited to, data communication mode ₁ to data communication mode N, where N is a positive integer. For example, the data communication mode can be any communication mode or format that can be utilized with unified communications (e.g., email, voice, instant messaging, voicemail, audio, video, etc.).

The distribution component 102 can leverage an email component 204 and/or a server component 206 in order to utilize a distribution group to route data communications. In particular, the distribution component 102 can employ a distribution group with an associated PSTN number and SIP URI that correlates to a member and/or entity of such group. It is to be appreciated that the email component 204 can be any suitable email application, software, hardware, device, etc., wherein electronic mail messages can be at least one of created, received, sent, stored, and/or drafted. For instance, the email component 204 can include various distribution groups created for email routing and/or directing. The distribution component 204 can extend and/or enable the email distribution group to be utilized for voice communication routing by linking a PSTN number and a SIP URI to the distribution group and respective members/entities. In particular, the server component 206 can include details associated with various members, entities, SIP URIs, PSTN numbers, email distribution group members, etc. to allow a distribution group to route and/or direct data communications. For instance, the server component 206 can include properties (e.g., members, contact information, email address, etc.) related to an email distribution group in which the distribution component 102 can leverage in order to generate routing and/or redirecting capabilities for voice communications using the membership of such group by linking a PSTN number and SIP URI for each member of the email distribution group. Thus, the email distribution group can be utilized to route voice data communications utilizing the linked/mapped PSTN number and SIP URI for the member/entity of the distribution group.

In one example, an email distribution group named DG1 can include user A and user B with email addresses userA@email.com and userB@email.com respectively. Thus, any email directed to the distribution group DG 1 can be automatically routed to user A and user B at their respective email addresses. The distribution component 102 can extend such email distribution group (e.g., DG1) so as to enable voice communication redirection and/or routing by linking the PSTN number and SIP URI related to user A and user B. Thus, an option can provide to enable DG1 to route voice communications when a particular PSTN number is contacted. The DG1 can be linked to a PSTN number, wherein upon activation of the PSTN number (and the DG1), the voice communication is directed to user A and user B and their respective SIP URIs. It is to be appreciated that such employment of the distribution group to voice communications can be automatic with little or no user interaction other than enabling the option to extend an email distribution group to voice communications.

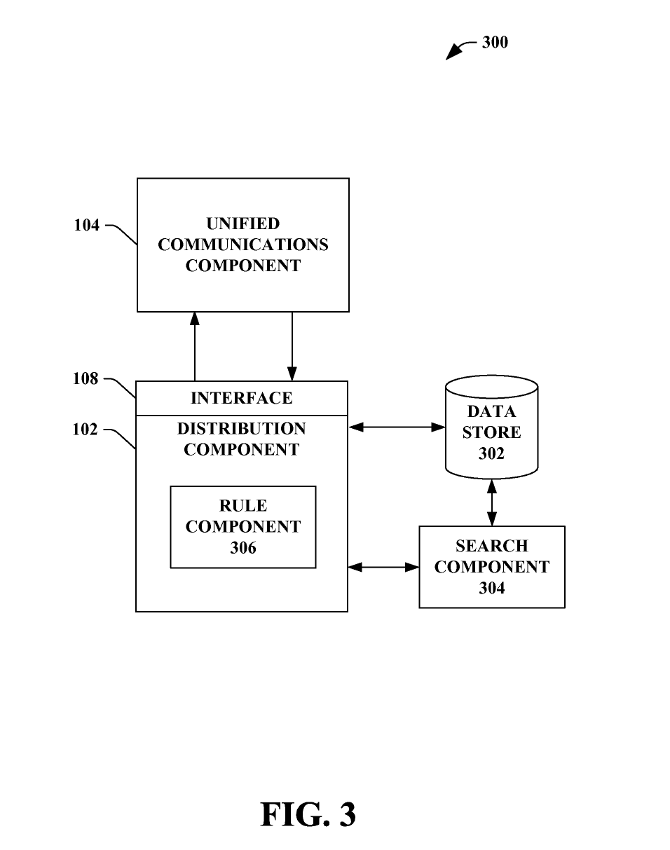

FIG. 3 illustrates a system 300 that facilitates managing a distribution group across a plurality of data communication modes within unified communications. The system 300 can include the distribution component 102 that can automatically route voice communications utilizing a distribution group associated with a PSTN number and a SIP URI for each member and/or entity of such group. Furthermore, the distribution component 102 can utilize such distribution group in connection with a plurality of data communication modes related to unified communications provided by the unified communication component 104. It is to be appreciated that the distribution component 102 can extend any distribution group related to any data communication mode within unified communications to be applicable to routing voice communications by linking a PSTN number and member SIP URIs.

In general, the system 300 can unify the concept of a distribution group and a voice hunt group. Moreover, the system 300 can remove administrative loads required for administering a hunt group by voice enabling a distribution group related to email, instant messaging, video, etc. For example, when a user creates an email distribution group (e.g., associated with a server application, a server, a network, etc.), the user can choose a PSTN number for the distribution group and gets a SIP URI for the distribution group along with the email address. The distribution group can then be used for voice communications and can further appear in a directory as an entity that users can send emails to or start a voice conversation with (discussed in more detail below). Furthermore, the distribution group can be utilized for “persistent chat” rooms where there is a persistent conference associated with the distribution group that users can join and leave (discussed in more detail below).

The system 300 can include a data store 302 that can include any suitable data related to the distribution component 102, the unified communications component 104, a data communication mode, a distribution group, a member/entity within a distribution group, and/or any suitable data associated with the system 300. For example, the data store 302 can include, but not limited to including, distribution group rules (discussed below), distribution group membership, distribution group privacy, a PSTN number, an SIP URI, an email distribution group, a distribution group related to a data communication mode/format, contact information related to a member/entity (e.g., PSTN number, SIP URI, email address, instant messaging alias, mailbox number, voicemail number, etc.), user preferences for distribution groups, etc.

It is to be appreciated that the data store 302 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 302 of the subject systems and methods is intended to comprise, without being limited to, these and any other suitable types of memory. In addition, it is to be appreciated that the data store 302 can be a server, a database, a hard drive, a pen drive, an external hard drive, a portable hard drive, and the like.

The system 300 can further include a search component 304 that facilitates querying data. The search component 304 can enable a user and/or machine to search data related to the system 300 and, in particular, query data stored in the data store 302. Thus, a user can utilize the search component 304 to search for distribution groups, members of distribution groups, contact information, email addresses, PSTN numbers, SIP URIs, instant messaging aliases, etc. In addition, it is to be appreciated that the search component 304 can be utilized by any user and/or machine independent of locality and/or remotely. In other words, a remote user (e.g., on a disparate system, network, etc. from the system 300) can access the search component 304 to locate a particular distribution group for data communications. For instance, a distribution group associated with company A can be searched and found by user B at enterprise C.

The distribution component 102 can further utilize a rule component 306 that can specify at least one rule and/or option related to a distribution group. The rule component 306 can provide details associated with how voice communications are handled in connection with the distribution groups that link PSTN numbers and/or SIP URIs. Such options and/or details provided by the rule component 306 can be, but are not limited to, ringing options for members (e.g., number of rings, types of rings, when to ring, who to ring, etc.), which members to contact/ring (e.g., contact a portion of the membership, exceptions for members of the distribution group, hierarchy of which members to ring, etc.), distribution group security/privacy (e.g., exposure only inside a network, exposure outside a network, universal exposure, portion of access to distribution group to a portion of entities, etc.), distribution group access (e.g., locally, remotely, corporate, employee hierarchy related, management, etc.), reserves and/or on call options, non-answered call options (e.g., voicemail, re-direct to distribution group, re-route, general mailbox for distribution group, etc.), duration of ringing, distribution group membership definitions (e.g., membership defined, etc.), voicemail settings for missed calls associated with a distribution group, edit/manipulation of a distribution group, setup of distribution groups, configuration of distribution groups, etc.

For example, rules can specify how data communications are handled, wherein such rules can be any of the following: 1) ring “present” members/entities (e.g., ring members/entities with presence states “online” or members/entities who are not in a call, data communication, contact members who et status as “available” or “accepting data communications,” etc.); 2) specify a limit on quantity of members/entities to activate within a distribution group (e.g., contact five of ten members within the distribution group, contact a portion of the distribution group in order to optimize data communication handling, etc.); 3) enable non-answered call options (e.g., send to voicemail, send to a shared distribution group voicemail box, send to distribution group owner mailbox, send missed data communications to all members, send missed data communications to a portion of members of the distribution group, notify a portion of the distribution group of the missed call utilizing a data communication mode such as email, instant messaging, audio, video, etc.); 4) incoming data communication activation for members for the distribution group (e.g., simultaneous ring for a portion of members, a particular order of ringing for members, a hierarchy of members for receiving communications, a round-robin ringing for members, and/or any combination of the foregoing, etc.); and 5) enable distribution groups to contain disparate distribution groups (e.g., specify how a nested distribution group can be handled, whether nested distribution groups can be ringed simultaneously, round-robin, a portion to ring simultaneously, a portion to ring round-robin, and/or any combination thereof, etc.). In a particular example, the distribution group can be linked to a unified “voice message box” in an email application and/or component (as discussed in item 3 above). The unified voice message box can store voicemails for the distribution group. Thus, if the distribution group BILLING included members A, B, and C, a voicemail associated with such distribution group can be stored in a unified voice message box a member of the distribution group can access. In addition, members of the distribution group can get a message waiting notification for voicemails in the unified voice message box.

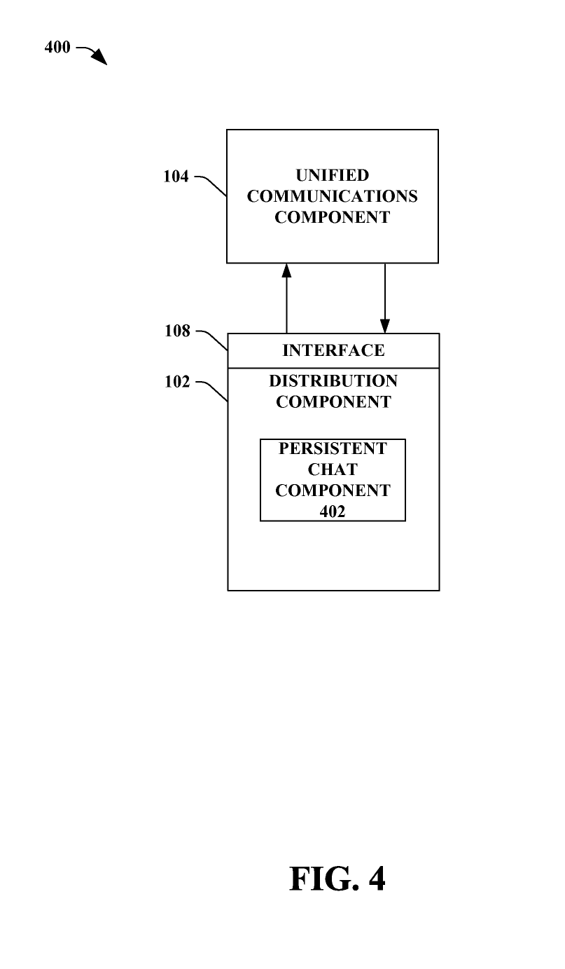

FIG. 4 illustrates a system 400 that facilitates extending an email distribution group to disparate data communications within a unified communication network to enable enhanced communication capabilities. The system 400 can include the distribution component 102 that can automatically transfer, route, and/or direct voice data communications within unified communications utilizing a distribution group. In particular, the distribution component 102 can implement a distribution group with a correlating PSTN number and SIP URIs for members/entities of the distribution group. Thus, when the PSTN number is activated, dialed, contacted, and/or initiated, the data communication can be directed to the various members of the distribution group located by the SIP URIs. It is to be appreciated that the distribution component 102 can utilize such distribution groups within unified communications employed by the unified communications component 104.

The distribution component 102 can utilize a persistent chat component 402 that can allow real-time communications and/or associate a “status” with members of a distribution group. For instance, the persistent chat component 402 can enable persistent chat rooms to be associated with distribution groups based at least in part upon SIP URIs corresponding to such distribution groups. With such chat rooms, members and/or the distribution group itself can include a “status” that is published and/or exposed. In other words, members and/or the distribution group itself can have a presence blob associated with the unified communication component 104 and/or within the network, server, application, etc. The status and/or presence can indicate whether a member/entity is available, busy, in a meeting, in a communication, on vacation, on lunch, away from desk, not available, sick, working from home, not to be disturbed, etc. It is to be appreciated that the status and/or presence can be any suitable description that can indicate a status of a member of the distribution group. The status and/or presence can be provided for each member of the distribution group, wherein such distribution group can be utilized for chatting, contacting, instant messaging, email, voice communications, and the like.

For example, a distribution group can include user A, user B, user C, and user D, wherein user A is available, user B is on lunch, user C is out of office, and user D is available. A list of aliases, members, entities, etc. can be related to an instant messaging application and/or chat application, wherein such listing can include the distribution group with respective members (e.g., user A, user B, user C, and user D). If a chat is initiated with the distribution group, users A and D would be available for chatting, wherein users B and C would not. Moreover, it is to be appreciated that the status can be dynamically updated in real-time, so as to allow user B and/or user C to enter the chat room for the distribution group if one of them become available.

In another example, the distribution component 102 can utilize the status and/or presence of each member of a distribution group to configure various options for the distribution group (e.g., ringing, membership, non-answer options, reserves, on call membership, etc.). For instance, if a particular portion of distribution group members are unavailable, a portion of “reserve” and/or “on call” members/entities can be called upon to receive data communication for such distribution group during low membership periods/durations. Thus, the distribution group can further include a primary set of members and a reserve and/or secondary set of members. In another example, a disparate distribution group can act as a reserve and/or on call for a distribution group.

The distribution component 102 can further enable a distribution group membership to be hidden and/or private. The distribution group members and/or entities can be hidden and/or private to at least a portion of viewers (e.g., local or remote entities accessing the distribution group for use). For example, the members for a particular distribution group can be hidden from users but may be seen by the owner and/or creator of the distribution group. A distribution group with hidden membership can show its own presence as available when one or more members are available. Other users can send email or call the distribution group without having the knowledge of the members of the group (e.g., names, contact information, location, etc.). It is to be appreciated that the hidden and/or private technique can be employed widely in a call center type application and/or call center system.

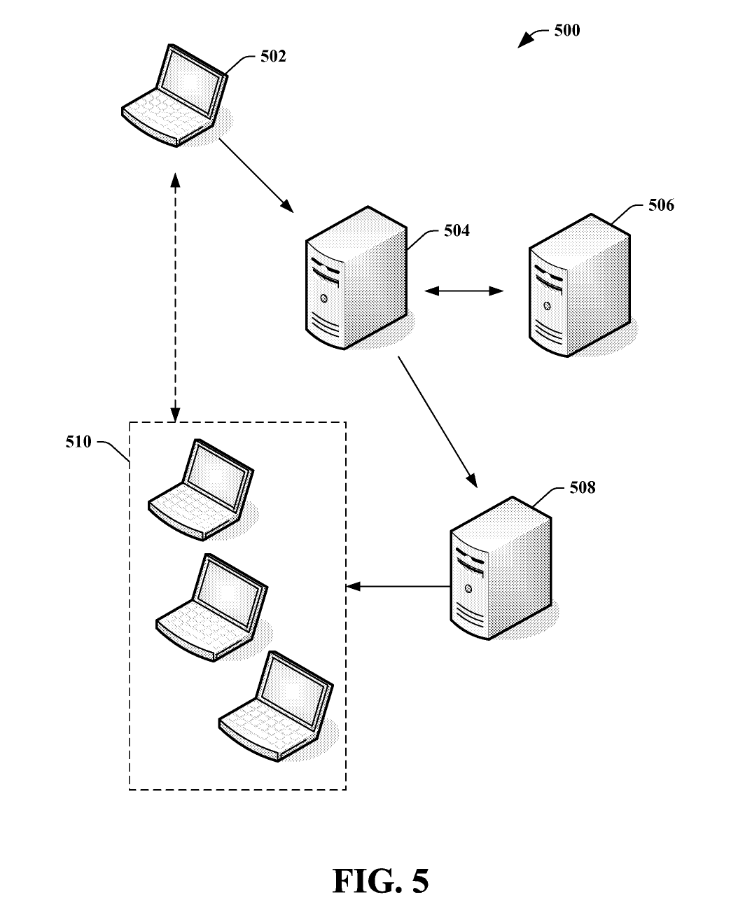

FIG. 5 illustrates a system 500 that facilities directing an incoming data communication utilizing a distribution group in connection with unified communications. The system 500 can utilize the distribution component (not shown) in order to automatically route a voice data communication with a distribution group, wherein the distribution group can include a PSTN number and a SIP URI. Moreover, the distribution group can be created from an email distribution group. In general, it is to be appreciated that the distribution group can be created from any suitable distribution group related to any data communication mode/format (e.g., email distribution group, instant messaging distribution group, etc.).

The system 500 can include a caller 502 that can initiate a data communication to a distribution group. It is to be appreciated that the distribution group can be created and setup for the system 500, wherein setup can include associating members, PSTN numbers, SIP URIs, rules, etc. The caller 502 can be any suitable machine, user, user with a machine, computer, etc. A server 504 can query a policy associated with the distribution group and/or expand the membership of the distribution group. It is to be appreciated and understood that the server 504 can be related to a unified communications system and/or server such as, but not limited to, a unified communications component (discussed above). The server 504 can identify a policy and/or expand membership by accessing a directory 506, wherein the directory 506 can be a directory service associated with an operating system that is a centralized and standardized system that automates network management of user data, security, distributed resources, directory interoperation, etc. Note that in a case of hidden and/or private distribution groups, the server 504 may not expand the distribution group and intimates the conferencing server of the policy associated with the caller 502 (e.g., allowing the conferencing server to conceal the identify of the called party from the caller 502). Once the server 504 identifies set policies, it can proceed to either ring the distribution group members directly or though a conferencing server (e.g., a multipoint conferencing component 508). For example, the server 504 can create and/or generate a conference with a multipoint conferencing component 508 based upon the set of policies and/or the expanded distribution group. Thus, the incoming data communication from the caller 502 can be automatically routed to members 510 of the distribution group. Moreover, the distribution group can include any suitable number of members and is not to be limited to the illustration of three members 510 in FIG. 5.

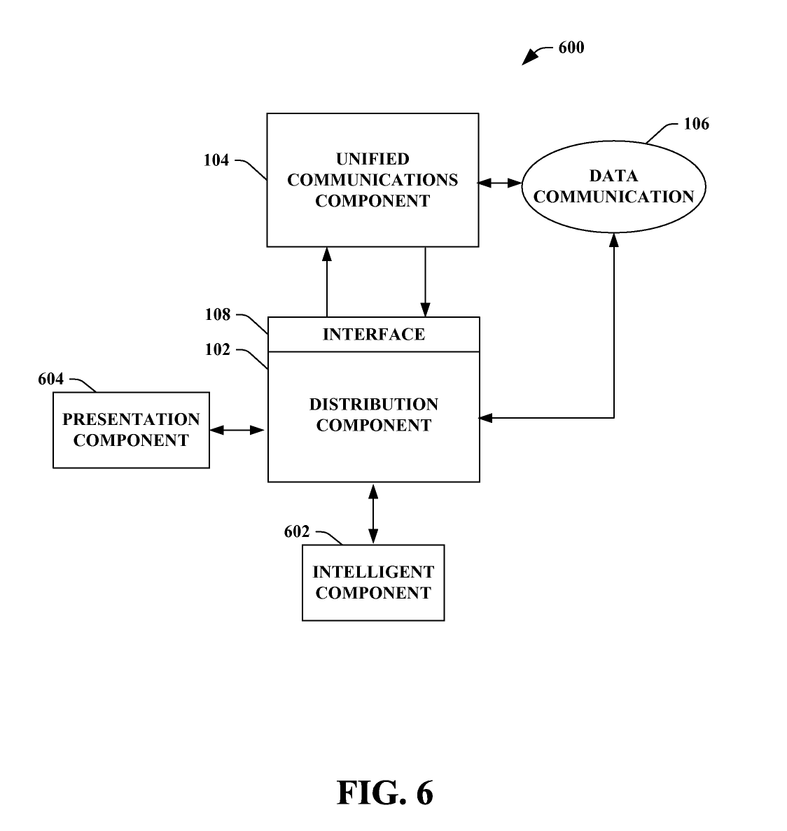

FIG. 6 illustrates a system 600 that employs intelligence to facilitate extending an email distribution group to disparate data communications within a unified communication network to enable enhanced communication capabilities. The system 600 can include the distribution component 102, the unified communications component 104, the data communication 106, and the interface 108. It is to be appreciated that the distribution component 102, the unified communications component 104, the data communication 106, and the interface 108 can be substantially similar to respective components, communications, and interfaces described in previous figures. The system 600 further includes an intelligent component 602. The intelligent component 602 can be utilized by the distribution component 102 to facilitate automatically routing and/or directing voice data communications utilizing distribution groups with PSTN numbers and SIP URIs. For example, the intelligent component 602 can infer policies and/or rules associated with a distribution group, membership to a distribution group, non-answered call options, reserve and/or on call members, ringing options, user/member preferences, privacy settings, PSTN numbers, SIP URIs, email distribution group correlation (e.g., which email distribution groups to extend to voice communication distribution, etc.), status for a member, chat settings/configurations, locality of distribution groups, remote options for distribution groups, nested distribution group settings/rules, etc.

It is to be understood that the intelligent component 602 can provide for reasoning about or infer states of the system, environment, and/or user from a set of observations as captured via events and/or data in order to distribution data communications in accordance with the subject innovation. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority. For example, the claimed subject matter can utilize the intelligent component 602 in relation with a server and/or entity that can distribute data communications to various members in accordance with a distribution list.

The distribution component 102 can further utilize a presentation component 604 that provides various types of user interfaces to facilitate interaction between a user and any component coupled to the distribution component 102. As depicted, the presentation component 604 is a separate entity that can be utilized with the distribution component 102. However, it is to be appreciated that the presentation component 604 and/or similar view components can be incorporated into the distribution component 102 and/or a stand-alone unit. The presentation component 604 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into the distribution component 102.

The user can also interact with the regions to select and provide information via various devices such as a mouse, a roller ball, a keypad, a keyboard, a pen and/or voice activation, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can then provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

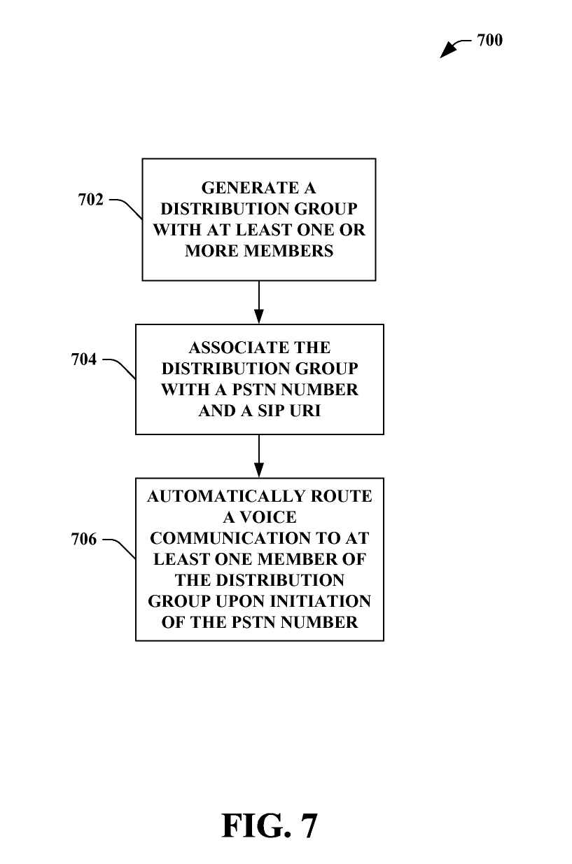

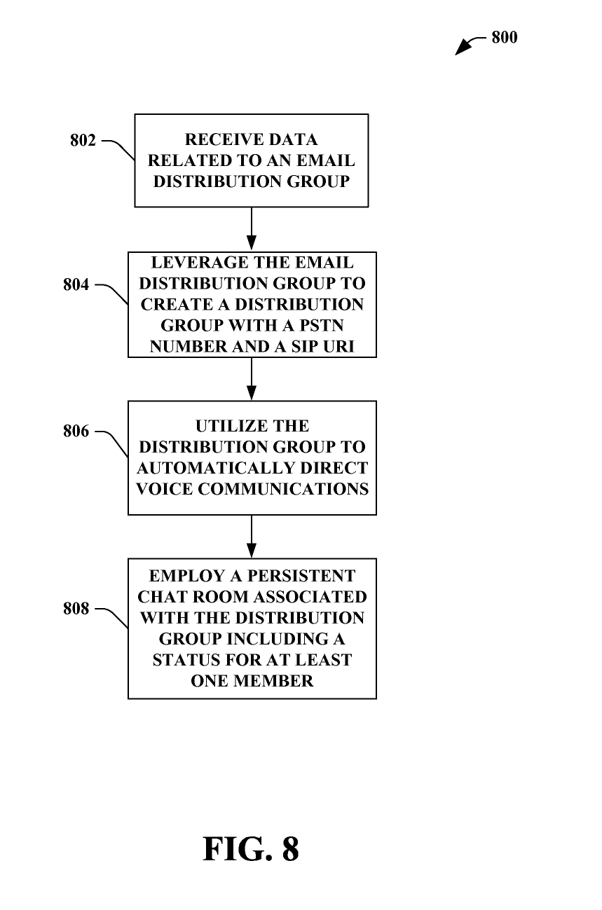

FIGS. 7-8 illustrate methodologies and/or flow diagrams in accordance with the claimed subject matter. For simplicity of explanation, the methodologies are depicted and described as a series of acts. It is to be understood and appreciated that the subject innovation is not limited by the acts illustrated and/or by the order of acts. For example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 7 illustrates a method 700 that facilitates utilizing a distribution group to route data communications within unified communications. The methodology 700 can be utilized to generate a distribution group that correlates to a PSTN number and an SIP URI in order to automatically route voice data communications directed toward the PSTN number. At reference numeral 702, a distribution group with at least one or more members can be generated. For instance, the distribution group can include any suitable number of members and/or entities, wherein the members and/or entities can be a user, a machine, a computer, an automated calling center, a person, a corporation, a department, and/or any suitable entity that can handle a voice communication.

The distribution group created can further include various policies and/or rules associated with handling voice communications. For example, the rules and/or policies can be related to ringing options for members, which members to contact/ring, distribution group security/privacy, distribution group access, reserves and/or on call options, non-answered call options, duration of ringing, distribution group membership definitions, voicemail settings for missed calls associated with a distribution group, edit/manipulation of a distribution group, setup of distribution groups, configuration of distribution groups, etc.

At reference numeral 704, the distribution group can be associated with a public switched telephone network (PSTN) number and a session initiation protocol (SIP) uniform resource identifier (URI). Thus, the distribution group with respective member(s) and rule(s) can be linked to a PSTN number and a SIP URI. At reference numeral 706, a voice communication can be automatically routed to at least one member of the distribution group upon initiation of the PSTN number. By linking the PSTN number to the distribution group with respective numbers, a voice communication targeted for the PSTN number can be automatically directed and/or routed to a portion of the distribution group members. Moreover, it is to be appreciated that the rules and/or policies associated with the distribution group can be employed to ensure seamless implementation of voice communication traffic regulation.

FIG. 8 illustrates a method 800 for integrating an email distribution group to data communications within unified communications. At reference numeral 802, data related to an email distribution group can be received. For example, the data related to an email distribution group can be a member list, a portion of contact information for a member (e.g., an email address, an Internet protocol (IP) address, a phone number, a name, a PSTN number, a SIP URI, etc.), a rule or policy associated with the distribution group (e.g., a priority, a hierarchy, a data routing option, privacy setting, etc.), a reference and/or name related to the distribution group, and/or any other portion of data associated with an email distribution group that can be leveraged to generate a distribution group for voice communications.

At reference numeral 804, the email distribution group can be leveraged to create a distribution group with a PSTN number and a SIP URI. For example, an email distribution group can include various members, member email addresses, and/or a reference name in which an email communication directed to the reference name can be routed to the email addresses of the various members. By leveraging the email distribution group, members, and member contact information, a voice communication distribution group can be created to route and/or automatically direct voice communications. In particular, the email distribution group can be utilized to create a distribution group that includes a correlating a PSTN number and a SIP URI. For example, the email distribution group can define membership, reference name, and/or contact information (e.g., member names, member phone numbers, etc.). At reference numeral 806, the distribution group can be utilized to automatically direct a voice communication. Thus, a voice communication targeted for the distribution group and/or the PSTN number can be automatically routed and/or directed to the members of such distribution group (e.g., in a substantially similar manner as an email targeted to an email distribution group).

At reference numeral 808, a persistent chat room associated with the distribution group can be employed, wherein the persistent chat room can include a status for at least one member of the distribution group. For instance, the persistent chat room can be associated with distribution groups based at least in part upon SIP URIs corresponding to such distribution groups. With such chat rooms, members and/or the distribution group itself can include a “status” that is published and/or exposed. The status and/or presence can indicate whether a member/entity is available, busy, in a meeting, in a communication, on vacation, on lunch, away from desk, not available, sick, working from home, not to be disturbed, etc. It is to be appreciated that the status and/or presence can be any suitable description that can indicate a status of a member of the distribution group. The status and/or presence can be provided for each member of the distribution group, wherein such distribution group can be utilized for chatting, contacting, instant messaging, email, voice communications, and the like. In other words, the distribution group can be a gateway to initiate communications (e.g., email, voice, audio, video, instant messaging, etc.) with members of the distribution group.

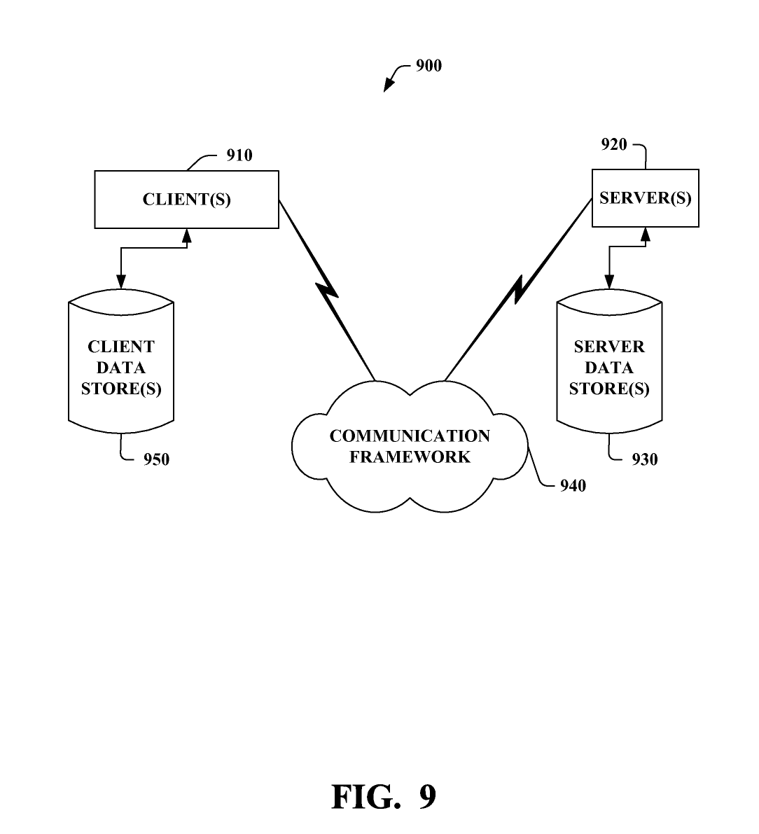

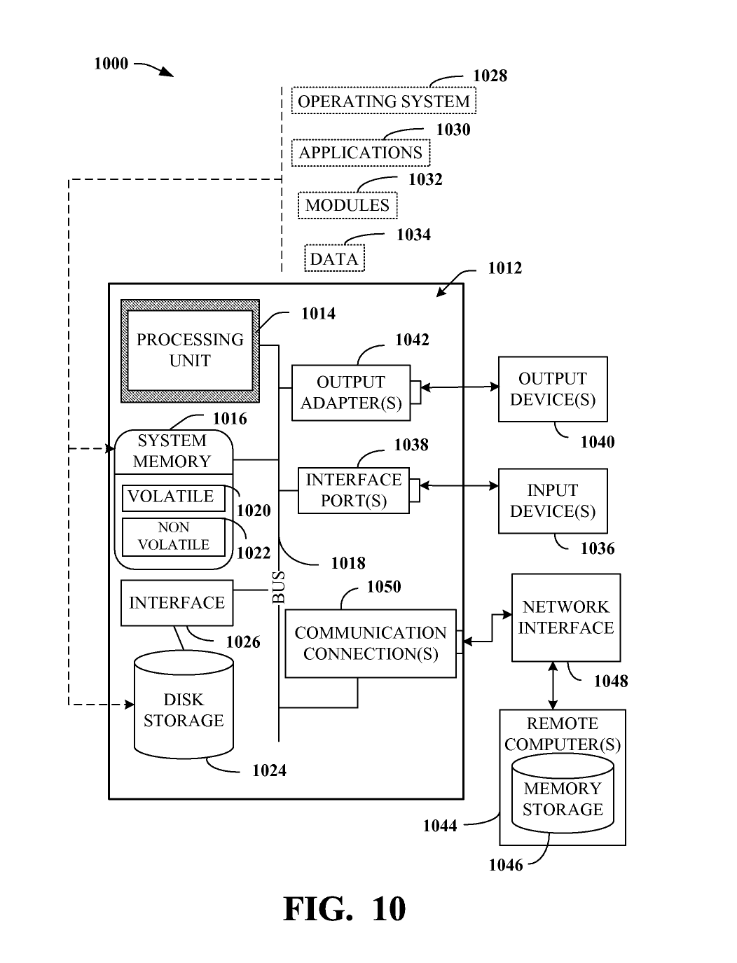

In order to provide additional context for implementing various aspects of the claimed subject matter, FIGS. 9-10 and the following discussion is intended to provide a brief, general description of a suitable computing environment in which the various aspects of the subject innovation may be implemented. For example, a distribution component that facilitates employing a distribution group to automatically route voice communications within unified communications, as described in the previous figures, can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 9 is a schematic block diagram of a sample-computing environment 900 with which the claimed subject matter can interact. The system 900 includes one or more client(s) 910. The client(s) 910 can be hardware and/or software (e.g., threads, processes, computing devices). The system 900 also includes one or more server(s) 920. The server(s) 920 can be hardware and/or software (e.g., threads, processes, computing devices). The servers 920 can house threads to perform transformations by employing the subject innovation, for example.

One possible communication between a client 910 and a server 920 can be in the form of a data packet adapted to be transmitted between two or more computer processes. The system 900 includes a communication framework 940 that can be employed to facilitate communications between the client(s) 910 and the server(s) 920. The client(s) 910 are operably connected to one or more client data store(s) 950 that can be employed to store information local to the client(s) 9 10. Similarly, the server(s) 920 are operably connected to one or more server data store(s) 930 that can be employed to store information local to the servers 920.

With reference to FIG. 10, an exemplary environment 1000 for implementing various aspects of the claimed subject matter includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), or flash memory. Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 also includes removable/non-removable, volatile/non-volatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in the suitable operating environment 1000. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the claimed subject matter can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

There are multiple ways of implementing the present innovation, e.g., an appropriate API, tool kit, driver code, operating system, control, standalone or downloadable software object, etc. which enables applications and services to use the advertising techniques of the invention. The claimed subject matter contemplates the use from the standpoint of an API (or other software object), as well as from a software or hardware object that operates according to the advertising techniques in accordance with the invention. Thus, various implementations of the innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A system that facilitates routing an incoming data communication in connection with unified communications, comprising:
a unified communications component that employs unified communications for a data communication with at least the following data communication modes: an email data communication mode, a voice data communication mode, an instant messaging data communication mode, and a voicemail data communication mode; and
a distribution component that automatically routes a voice data communication to a member utilizing a distribution group, the distribution group includes at least one member with a public switched telephone network (PSTN) number and a session initiation protocol (SIP) uniform resource identifier (URI).

2. The system of claim 1, the data communication mode includes at least one of an audio data communication mode, a video data communication mode, an instant messaging data communication mode, a desktop sharing data communication mode, or an application sharing data communication mode.

3. The system of claim 1, the unified communications component is an integrated enterprise communication client that provides real-time communications utilizing unified communications.

4. The system of claim 1, the distribution component leverages an email distribution group utilized by an email component; the email distribution group is reused to create a distribution group that is linked to a PSTN number and a SIP URI which enables voice data communication routing.

5. The system of claim 4, the email distribution group enables voice communication routing by providing at least one of a membership list associated with a distribution group, a reference name for the distribution group, a portion of contact information for a member, or a rule associated with the email distribution group.

6. The system of claim 4, further comprising a server component that is leveraged by at least one of the email component or the distribution component to create the distribution group, the server component can include a portion of data related to at least one of a member, an SIP URIs, a PSTN number, or an email distribution group member.

7. The system of claim 1, further comprising a voice over Internet protocol (VoIP) network that utilizes the PSTN phone number and SIP URI related to the distribution group.

8. The system of claim 1, further comprising a rule component that specifies handling of the voice communication which includes at least one of a ringing option for a member, which member to contact/ring, distribution group security/privacy, distribution group access, a reserve option, a non-answered call option, a duration of ringing, a distribution group membership definition, blocking a communication based upon a member of the distribution list being hidden, or a voicemail setting for a missed call associated with the distribution group.

9. The system of claim 8, the rule component further handles a voice communication with at least one of the following: ringing a “present” member; specifying a limit on a quantity of members to activate within a distribution group; enabling a non-answered call option such as sending a missed communication to at least one of a voicemail, a shared distribution group voicemail box, a distribution group owner mailbox, or a mailbox for a portion of distribution group members; configuring an incoming data communication activation option for members for the distribution group including at least one of a simultaneous ring for a portion of members, a particular order of ringing for members, a hierarchy of members for receiving communications, or a round-robin ringing for members; or enabling distribution groups to contain a disparate distribution group.

10. The system of claim 1, the distribution group is activated by at least one of an internal entity, an external entity, a local entity, or a remote entity, the entity is at least one of a machine, a user, a computer, a device, an enterprise, or a component.

11. The system of claim 1, further comprising a search component that facilitates querying data related to at least one of the distribution group, a member of the distribution group, a rule associated with the distribution group, a PSTN number, a SIP URI, or a distribution group reference name.

12. The system of claim 1, further comprising a persistent chat component that employs at least one of a persistent chat room associated with the distribution group and at least one respective member utilizing the SIP URI, wherein the distribution group is a prime identifier of the persistent chat room; or a status corresponding to availability for a member of the distribution group.

13. The system of claim 12, the distribution group is employed to initiate a data communication with at least one member, the data communication is at least one of chatting, contacting, instant messaging, email, or a voice communication.

14. The system of claim 1, the distribution component enables a portion of a membership listing associated with the distribution group to be at least one of hidden or private.

15. A computer-implemented method that facilitates automatically routing a voice communication within unified communications, comprising:
generating a distribution group with at least one or more members;
associating the distribution group with a PSTN number and a SIP URI; and
automatically routing a voice communication to at least one member of the distribution group upon initiation of the PSTN number.

16. The method of claim 15, further comprising:
receiving a portion of data related to an email distribution group;
leveraging the email distribution group to create a distribution group for voice communication routing; and
extending the email distribution group to voice communication by linking a PSTN number and a SIP URI to the distribution group and a respective member.

17. The method of claim 15, further comprising employing a persistent chat room associated with the distribution group to enable real-time communications with at least one member of the distribution group.

18. The method of claim 15, the distribution group includes a status for a portion of members within the distribution group, the status correlates to availability for data communication.

19. The method of claim 15, further comprising enabling a portion of a membership listing associated with the distribution group to be at least one of hidden or private.

20. A computer-implemented system that facilitates routing an incoming data communication in connection with unified communications, comprising:
means for employing unified communications for a data communication with at least the following data communication modes: an email data communication mode, a voice data communication mode, an instant messaging data communication mode, and a voicemail data communication mode; and
means for automatically routing a voice data communication to a member utilizing a distribution group, the distribution group includes at least one member with a public switched telephone network (PSTN) number and a session initiation protocol (SIP) uniform resource identifier (URI).
